(19) United States
(12) Patent Application Publication
(10) Pub. No.: US 2008/0062940 A1
(43) Pub. Date: Mar. 13, 2008

(54) PRESENCE-BASED COMMUNICATION BETWEEN LOCAL WIRELESS NETWORK ACCESS POINTS AND MOBILE DEVICES

(75) Inventors: Konstantin Othmer, Mountain View, CA (US); Michael P. Ruf, Parkland, FL (US); Timo Bruck, Mountain View, CA (US); Bruce Alan Leak, Los Altos, CA (US); Joseph W. Poletto, Glen Ellen, CA (US); Thomas J. Ziola, Menlo Park, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Skypop.Inc., Mountain View, CA (US)

(21) Appl. No.: 11/840,878

(22) Filed: Aug. 17, 2007

Related U.S. Application Data
(60) Provisional application No. 60/822,728, filed on Aug. 17, 2006.

(51) Int. Cl. H04Q 7/24; H04B 7/005; H04Q 7/20

(52) U.S. Cl. 370/338; 370/278; 455/434

(57) ABSTRACT

Systems and methods for communication between local wireless networks and mobile devices and more particularly, to sending presence-based content to mobile devices over local wireless network access points. The method includes receiving notification that the mobile device has established a wireless network connection with a LWN through a WAP of the LWN; receiving a request from a content provider to send content through the WAP to the mobile device; allowing the content provider to send content to the mobile device through the WAP or other network connected to the mobile device. In one exemplary method, a wireless service provider or mobile device user can govern what content is sent to a mobile device.

### CROSS REFERENCE TO RELATED APPLICATIONS

This application claims the benefit of U.S. Provisional application Ser. No. 60/822,728, filed Aug. 17, 2006 and entitled PRESENCE-BASED COMMUNICATION BETWEEN LOCAL WIRELESS NETWORK ACCESS POINTS AND MOBILE DEVICES, which application is incorporated by reference in its entirety.

### BACKGROUND OF THE INVENTION

1. The Field of the Invention

The present invention relates generally to systems and methods for communication between local wireless networks and mobile devices. More particularly, exemplary embodiments of the invention relate to sending presence-based content to mobile devices over local wireless network access points.

2. The Relevant Technology

Mobile devices, such as cellular telephones and telephony enabled personal digital assistants (PDAs), are often designed to operate as subscribers within a wireless communication network which is managed by a wireless service provider. Although mobile devices have traditionally supported only telephony-related communication, mobile devices are increasingly designed with capabilities beyond simple telephony-type communication. For example, beyond being designed to establish relatively long-range wireless connections for voice communication, mobile devices can also establish relatively short-range wireless connections with wireless local area networks (WLANs) and wireless personal area networks (WPANs) (referred to herein collectively as “local wireless networks” or “LWNs”), in order to allow for additional means of communication for users.

A common feature of LWNs are wireless access points (WAPs). A WAP may be a two-way transceiver that connects wireless communication devices in a LWN. A WAP can relay data between a mobile device that is capable of communicating with a LWN (referred to herein as a “LWN-capable” mobile device) and other wireless communication devices and/or wired communication devices that are connected to the LWN. Each WAP of a LWN typically has a certain distance or range over which it is capable of transmitting and receiving data. This range can vary depending on a number of factors including indoor or outdoor placement, height above ground, nearby obstructions, type of antenna, the current weather, operating radio frequency, and the power output of the mobile devices.

A LWN-capable mobile device typically includes a wireless adapter that enables the mobile device to detect when it has come within range of a WAP of a LWN. Likewise, each WAP of a LWN is capable of determining when a LWN-capable mobile device has come within range of the WAP. Once a LWN-capable mobile device comes within range of a WAP, the LWN-capable mobile device can establish a wireless network connection to a LWN through the associated WAP. This connection allows wireless network communication between the LWN-capable mobile device and other LWN-capable mobile devices, wireless communication devices, and wired communication devices that are also connected to the LWN through the same WAP or another WAP of the same LWN.

When a LWN-capable mobile device connects to a LWN through a WAP, other devices connected to the LWN detect the LWN-capable mobile device. Often, these other devices are programmed to send communications to the LWN-capable mobile device. At the same time, many users do not want to receive certain unsolicited communications and/or may wish to receive other select communications, but they lack the ability to block undesirable content or to elect to receive desirable content that is sent to their LWN-capable mobile devices from other devices connected to the LWN.

Wireless service providers also have difficulty controlling the content that is sent to LWN-capable mobile devices. In other words, where an LWN-capable mobile device is configured to automatically connect to a WAP as soon as the mobile device comes within range of the WAP, wireless service providers have been unable to control the type of content that is sent to the LWN-capable mobile device over the WAP.

Wireless service providers also have problems notifying users about presence-based content that might be of interest to the user. As designated herein, “presence-based content” is used to designate communications that can be transmitted to a mobile device when it is proximate to or within range of the WAP. Specifically, wireless service providers have struggled to capitalize on their ability to identify and locate a particular LWN-capable mobile device within a particular LWN. Additionally, wireless service providers often have difficulties integrating presence-based information and sharing presence-aware data with devices which are not visible to their networks. Also, the accuracy of device location sensing data available to one wireless network may be diminished by unresolved gaps in coverage areas, unconfirmed location/proxy data, or other imperfections that may exist in any location/proximity data capture method.

This problem is complicated by the fact that when a device comes within range of a WAP, there is little if any user interface that enables the user to take advantage of and use the WAP. Instead, a user is required to access the wireless network settings of the device and then select an access point before being able to use the WAP. For many wireless access points, the user is then required to start a browsing application and then authenticate or register with the LWN that is being accessed through the WAP. Thus, the WAP provides content specifically associated with the WAP to the user via the browser, but the content is sent in response to a specific request from the user.

What is needed are systems and methods that enable content providers of the LWN to deliver content to the LWN-capable device based on the presence of the device in LWN and an intelligent mechanism for consolidating location and/or proximity data from multiple sources so as to allow a variety of devices on a variety of networks to become aware of other devices and to detect their proximity and location. Additionally, a system and method is needed whereby the devices are able to communicate across a variety of networks and types of devices.

### BRIEF SUMMARY OF THE INVENTION

The present invention relates generally to systems and methods for communication between local wireless networks and mobile devices and extending these capabilities to include features which are useful to users of dissimilar networks and devices. More particularly, exemplary embodiments of the invention relate to detecting and identifying a wireless access point (WAP) via a MAC address of the WAP or another signature broadcasted by the WAP, and/or detecting and identifying a mobile device in proximity of the WAP; determining authorized content providers and/or content associated with the WAP; determining whether the identified mobile device is on the list for receiving content, and; sending authorized content associated with the identified WAP to the identified mobile device via a wireless network.

In one embodiment, a content provider outside of a certain region may wish to communicate with people who are present or located in the region. This region is associated with the range of a particular WAP. Users of LWN-capable mobile devices located within the proximity of the region can be located via the ID of the WAP. As a user of a LWN-capable mobile device enters the range of the WAP, the proximity of the device to the WAP initiates the delivery of content from the content provider. The method may include identifying a LWN-capable mobile device by the device's MAC address, ESN or other signature. The method may also include checking the access list of the user's wireless service provider to verify that the content provider is authorized to provide content. A wireless network connection is then established with the device through a network, such as a WAP of the LWN or another network. Once the connection is established, a request is made to send content to the LWN-capable mobile device, and then the content can be pushed (or sent) to the device through the WAP of the LWN, or via other network using the WAP address.

In another embodiment, the device can detect and identify the network. One method may include determining the identity of the WAP by sniffing the MAC address of the WAP, or any other signature or identifier that is broadcast by the WAP or associated with the WAP, then communicating that ID or signature to a server. In this case, the server determines whether content is associated with that WAP ID and delivers it to the device. For example, in the case where the device is a dual mode WiFi/CDMA phone, the WiFi part of the phone can sniff local WiFi access points and “see” their identities even if it can't connect to the devices. In this case, the device can send the information about the local access point to a central server that uses that ID as an index to a content server. Thus, the communication with the device is not required to go through the WAP. Alternatively, of course, the communication with the device can also occur through the WAP.

In another embodiment, a wireless service provider can send presence-based content to a LWN-capable mobile device. In this example, after receiving notification that the LWN-capable mobile device has established a wireless network connection with a LWN through a WAP of the LWN, it is determined whether any content providers are located within a particular distance from the location of the WAP. Presence based content is then sent to the LWN-capable mobile device for each of the content providers that are located within the particular distance from the location of the WAP. A notification that content was received on the device can be automatically rendered on the device using any format including pop up windows, vibrations, and the like. Further, menus of the device can be populated with offers such that the user can browse received content using an existing menu structure.

In yet another embodiment, a user of the LWN-capable mobile device can be notified of available content on a user interface of the device. The method includes establishing a wireless network connection with a LWN through a WAP of the LWN; receiving content from a content provider that is network connected to the LWN; and presenting the content on the user interface if the content provider is authorized to send content to the LWN-capable mobile device.

In another embodiment, a device that may not otherwise be visible to a wireless provider's network can become visible to that network and other devices on that network. In addition, the device may subsequently communicate with a variety of wired and/or wireless devices on other networks. The method includes collecting location information from a variety of sources, regardless of the type of network. For example, the location information may be collected from WiFi beacons, GPS data sources, cell tower IDs, network router IDs, and Bluetooth IDs. Although some of the location data may overlap, by consolidating and sharing the data across a variety of devices and networks, the system is able to locate the device with greater accuracy than with standard systems which use only a single network to locate the device. Embodiments of the invention allow diverse ways to determine proximity to locations and to other devices that extend beyond what any one network may enable, even for other devices that on their own possess no intrinsic location-sensing capabilities.

These and other features of the present invention are described in further detail below and in the appended claims, or may be learned by the practice of the invention as set forth hereinafter.

### BRIEF DESCRIPTION OF THE DRAWINGS

In order that the manner in which the above-recited features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of a wireless communication network, as well as three local wireless networks, in which exemplary embodiments of the invention can be practiced;

FIG. 2 illustrates an exemplary implementation of a method for a content provider to send content to a LWN-capable mobile device;

FIG. 3 illustrates an exemplary implementation of a method for a wireless service provider to send presence-based content to a LWN-capable mobile device;

FIG. 4 illustrates an exemplary implementation of a method for notifying a user of a LWN-capable mobile device of available content;

FIG. 5A illustrates an exemplary environment which illustrates an implementation of a method for using multiple networks or devices to form a database which may be used to determine the proximity and location of a device; and

FIG. 5B illustrates an exemplary database which may be created using the method of FIG. 5A.

### DETAILED DESCRIPTION OF EMBODIMENTS OF THE INVENTION

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

In general, embodiments of the invention are concerned with communicating between local wireless networks and mobile devices. More particularly, exemplary embodiments of the invention relate to sending presence-based content to mobile devices that are capable of communicating with local wireless networks over access points of the local wireless networks.

Embodiments of the invention extend the functionality and reach of one or more systems to include wirelessly connected as well as wired devices through the use of multiple different types of location/proximity methodologies that, consolidated together, demonstrably enhance and improve proximity information for mobile and stationery devices and enable devices to be aware of and interact with many more types of connected devices and diverse wired and wireless networks. More particularly, embodiments of the invention relate to sending presence-based content to mobile devices over local wireless network access points and delivering such content across dissimilar types of connected devices through the creation and/or use of a database of presence-related data drawn from multiple sources that can, by consolidating the individual data elements from each different source, enhance the accuracy of presence data beyond what any one network or device type may be able to provide alone, thus allowing enhanced targeting, broader distribution, and more flexible content sharing across many of types of networks (using a WiFi beacon data, GPS data, cell tower data and IDs, network router data and IDs, and Bluetooth data and IDs) and device types (carrier band connected devices, non-carrier band connected devices, and LAN-based devices) than typically possible or feasible if such location/proximity data were otherwise limited to a subset of all possible connected devices and communications networks.

Embodiments of the invention relate to enabling local content providers (e.g., content providers with respect to the location of a WAP) to transmit content to enabled devices based at least on the presence of the devices. When a device comes in range of a wireless access point, a user can be presented various configurable options. For example, the localized content that the device may display on a screen or user interface may identify the services that are available near that wireless access point. In one example, the services identified in the pop up screen can be proximate to the wireless access point. In another example, the phone may provide a visual (e.g., service icon) and/or tactile (e.g., vibration) alert that provides notification that localized content is available over a detected wireless access point. In another example, the device may have a menu that can be automatically populated over the wireless access point with localized content. At any time, the user can browse the menu to discover any content that is associated with the wireless access point. The actual content can change as the user encounters other wireless access points.

Embodiments of the invention enable, for example, local businesses that are geographically near the access point or that provide the wireless access point to provide content to devices that are proximate to or within range of the wireless access point. For example, a restaurant may provide an order form or menu to any device that is connected through the restaurant's wireless access point. A restaurant that is proximate to a WAP of another provider may also be able to provide similar content.

Advantageously, it is not necessarily the location of the wireless access point or of the device that enables localized content to be delivered to the device, but the proximity of the device to the wireless access point that initiates the delivery of localized content. The content pushed to the device can be obtained in various manners. The content can be obtained directly from the wireless access point. Alternatively, the content can be obtained from another network or from a remote server. In the case of providing localized content, the address of the wireless access point or other unique identifier can be used as the key to identify the localized content that is obtained from the remote server and then pushed to the device. Embodiments of the invention also contemplate instances where content from the device is pushed to the local wireless network (such as when a device encounters a home network to download pictures, etc.).

Embodiments of the invention also include peer-to-peer situations. In this case, a LWN can be used to convey content from one device to another device also present in the LWN. Each device may be configured to have or act as a portal in one example. Other similarly configured devices can then “see” similar devices. Access or even notification of the availability of these portals can be controlled using, for example, a contact list. In this case, only contacts show up on a particular device. Non-similarly configured devices, furthermore, can “see” each other and share information and receive the same location and/or proximity information about other devices which may be nearby with greater accuracy. Additionally, the use of non-similarly configured devices may be used as an alternative method of acquiring the location information of devices, which may be useful in areas where the device network has limited connectivity, or when the network or device lacks location detecting capabilities.

Although access to a network is often via a local LWN, the LWNs are often required to register with a carrier. Thus, the carrier may also be able to provide access control in some instances. Further, the content from the local content providers can be provided to an advertising engine on the carrier's side of the network. This enables the carrier to use both the location of the device as well as the location of the LWN or WAP to also provide content that is related to the location of the device and/or LWN. For instance, a carrier can identify the location and distance to a particular establishment after that establishment registers with the carrier. These and other embodiments of the invention are more fully disclosed in the following description.

The term “local wireless network” or “LWN” is used herein to designate a wireless data network having a relatively short range such as, by way of example and not limitation, an IEEE 802.11 wireless local area network (WLAN) or an IEEE 802.15 wireless personal area network (WPAN). The term LWN is not limited to WLANs and WPANs, and can include any network to which a mobile device can connect by being near a wireless access point of the network. The term “mobile device” is used herein to designate any wireless telephony-enabled communication device such as a cellular telephone, a telephony-enabled personal digital assistant (PDA), a lap top computer, and the like or any combination thereof The features of the LWN could also be obtained through other types of networks, including a WiMax network or local Bluetooth connections, provided the information is consolidated and/or shared.

The term “presence-based content” is used herein to designate content that is dependent upon the presence or close physical proximity of the subject matter of the content or to the content provider. The term “local wireless network capable mobile device” or “LWN-capable mobile devices” is used herein to designate a mobile device that is capable of establishing a wireless network connection with a LWN in order to send and receive data from other devices connected to the LWN. The term “wireless access point” or “WAP” is used herein to designate a two-way radio transceiver that connects wireless communication devices together in a LWN. A WAP can relay data between a LWN-capable mobile device and wireless communication devices and/or wired communication devices that are network connected to the LWN. Each WAP of a LWN typically has a certain range over which it is capable of transmitting and receiving data. This range can vary depending on a number of factors including indoor or outdoor placement, height above ground, nearby obstructions, type of antenna, the current weather, operating radio frequency, and the power output of the mobile devices. For example, a particular WAP of an IEEE 802.11 LWN may have an average range of 150 feet indoors and 300 feet outdoors. In contrast, a particular WAP of an IEEE 802.15 LWN may have an average range of 30 feet.

I. Exemplary Wireless Communication Network and Associated Wireless Devices

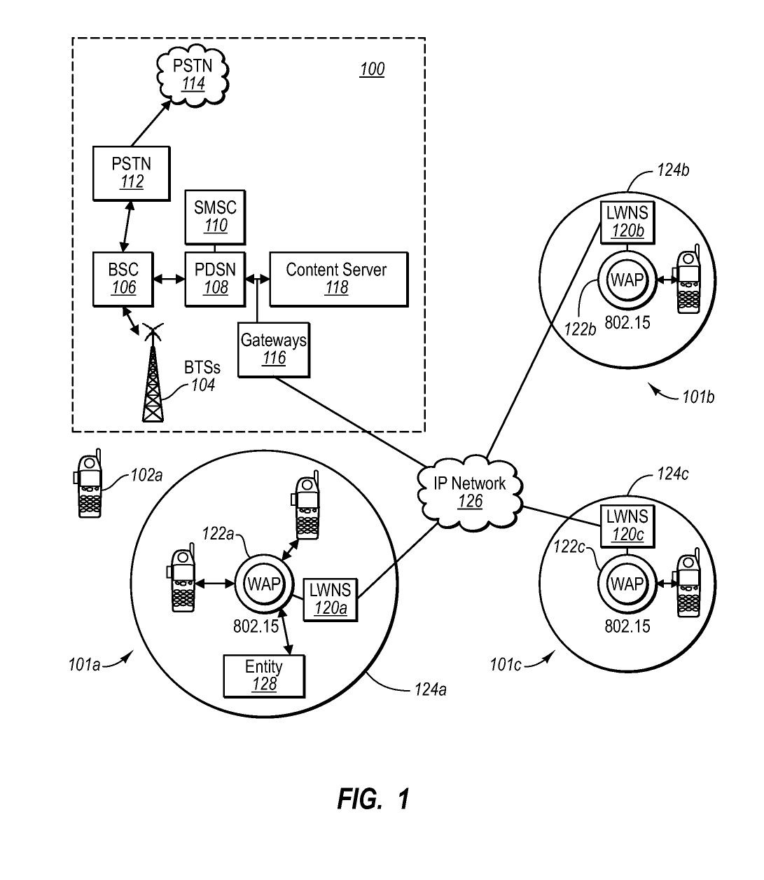

In order to describe the various methods of the invention, FIG. 1 illustrates an example of a wireless communication network 100, as well as three local wireless networks 101a, 101b and 101c, in which the invention can be practiced. It should be understood that this and other arrangements and processes described herein are set forth for purposes of example only, and other arrangements and elements may be practiced with the benefit of the teachings contained herein. Further, those skilled in the art will appreciate that many of the elements described herein are functional entities that may be implemented as discrete components or in conjunction with other components, in any suitable combination and location, and by software, firmware and/or hardware.

The wireless communication network 100 and three local wireless networks 101a, 101b and 101c of FIG. 1 represent only an example of the suitable environments in which the invention can be implemented and other network architectures or environments are possible. In particular, wireless communications network 100 is described and illustrated as a Code Division Multiple Access (CDMA) network, whereas the invention can be practiced with other wireless communications networks, including Global System for Mobile Communications (GSM), Universal Mobile Telecommunications System (UMTS), Time Division Multiple Access (TDMA), Wideband Code Division Multiple Access (WCDMA), General Packet Radio Service (GPRS) networks and other networks. Likewise, local wireless networks 101a, 101b and 101c are described and illustrated as including IEEE 802.11 and 802.15 wireless access points, whereas the invention can be practiced with local wireless networks including other types of wireless access points.

More specifically, in the illustrated exemplary embodiment of the invention, wireless communications network 100 comprises a radio frequency (RF) network that provides radio connectivity and session management for circuit-switched and packet data technology-based communication. Accordingly, wireless communications network 100 includes or interfaces with all of the elements necessary to route circuit-switched telephone calls and/or packet data communication through the network, including mobile devices 102a-102e, one or more base transceiver stations (BTSs) 104, a base station controller (BSC) 106, a packet data serving node (PDSN) 108, a short message service center (SMSC) 110, and a public switched telephone network (PSTN) 112 which connects to one or more other PSTNs 114. More specifically, the methods of the invention can be used in conjunction with a circuit-switched network, a packet data network, or both. While the exemplary embodiment of the invention uses Internet Protocol (IP) as its transport protocol, the methods of the invention may be implemented using other transport protocols, such as short message service (SMS) and Short Data Burst services. Wireless network 100 may also include one or more gateways 116 with which elements of local wireless networks 101a-101c can communicate. Content server 118 may reside outside network 100 and can be used in conjunction with the present invention. References herein to the term “wireless communication network” throughout should be construed as inclusive of the network infrastructure, servers, end user devices, applications and services of wireless communication network 100.

As depicted in FIG. 1, mobile devices 102a-102e are each subscribers to wireless communication network 100 that is managed by, or affiliated with, a wireless service provider. As used herein, the term “wireless service provider” refers to the entity that controls a wireless communication network, such as wireless communication network 100. As subscribers to wireless communication network 100, each of mobile devices 102a-102e can communicate through the base transceiver stations 104 in order to communicate, using telephony or other technologies such as SMS and MMS, with other devices on wireless communication network 100 or other communication networks that are connected to wireless communication network 100.

Each of mobile devices 102a-102e is also LWN-capable. In other words, beyond having the capability of communicating with wireless communication network 100, each of mobile devices 102a-102e is capable of communicating with local wireless networks 101a-101c. Although as illustrated each of mobile devices 102a-102e is capable of establishing a network connection over both IEEE 802.11 and IEEE 802.15 technology, in another embodiment, one or more devices 102a-102e can be capable of establishing a network connection over either IEEE 802.11 or IEEE 802.15 , but not both.

Local wireless networks 101a-101c include local wireless network servers (LWNS) 120a-120c, respectively. Network connected to local wireless network servers 120a-120c are wireless access points (WAPs) 122a-122c, respectively. The connections between LWNSs 120a-120c and WAPs 122a-122c, respectively, can either be wired or wireless. Although only one WAP is illustrated for each of local wireless networks 101a-101c, local wireless networks 101a-101c can each include more than one WAP.

Each of WAPs 122a-122c has a range within which the WAP is capable of transmitting and receiving data signals from other devices. In FIG. 1, these ranges are illustrated by boundaries 124a-124c. The ranges may depend on signal strength, environmental conditions, type of network, and the like or any combination thereof. As illustrated, the range for WAP 122a is greater than the range for WAP 122b and WAP 122c. This is due to the fact that WAP 122a is an IEEE 802.11 WAP with a stronger signal than WAPs 122b and 122c, which are each IEEE 802.15 WAPs with a comparatively weaker signal. As depicted, WAP 122a has average range of 150 feet. In contrast, WAPs 122b and 122c have an average range of 30 feet. Depending on a variety of factors, including those mentioned above, in other implementations the ranges of WAPs 122b and 122c can be greater than the range of WAP 122a.

When one of mobile devices 102a-102e is physically located within the ranges 124a-124c of any of WAPs 122a-122c, the mobile device is designed to detect the WAP and connect through the WAP to the corresponding LWN. Likewise, when one of mobile devices 102a-102e is physically located within range of any of WAPs 122a-122c, the WAP is designed to detect the mobile device and facilitate a connection between the LWN corresponding to the WAP and the detected mobile device. In this example, the range of each WAP 122a-122c corresponds with the range of a LWN 101a-101c, respectively. As illustrated, mobile devices 102b and 102c are physically located within the range 124a of LWN 101a, mobile device 102d is physically located within the range 124b of LWN 101b, and mobile device 102e is physically located within the range 124c of LWN 101c.

According to one embodiment, each of LWNSs 120a-120c is network connected to IP Network 126. IP Network 126 can be any type of IP network, including the Internet. As depicted, one or more gateways 116 of wireless communication system 100 can also be connected to IP Network 126, which enables each of LWNSs 120a-120c to communicate with content server 118. Optionally, the content server 118 may also be a content authorization server, which is capable of storing and maintaining information relating to content providers who are authorized to send content to each mobile device user. Thus, according to one embodiment, the content server 118 controls which content providers that are connected to LWNs 101a-101c are allowed to send content to and receive content from the mobile devices that are subscribers to wireless communication network 100.

FIG. 1 further illustrates an entity 128 that is proximate to the LWN 120a. Embodiments of the invention enable the entity 128 to deliver content to the device 102b or to the device 102c, which are within the range of the WAP 122a. As described more fully below, the presence of the device 102b may trigger delivery of content that is associated with the entity 128. For example, the entity may be a business and the content is an advertisement or coupon that is delivered to the device 102b. Alternatively, the entity 128 may be a home server of device user 102b and the LWNS 120a may be the user's home network. In this case, the detection of the presence of the device 102b may lead to the delivery of content from the entity 128 to the device 102b as well as the delivery of content from the device 102b to the entity 128.

II. Method for Sending Content to a LWN-Capable Mobile Device

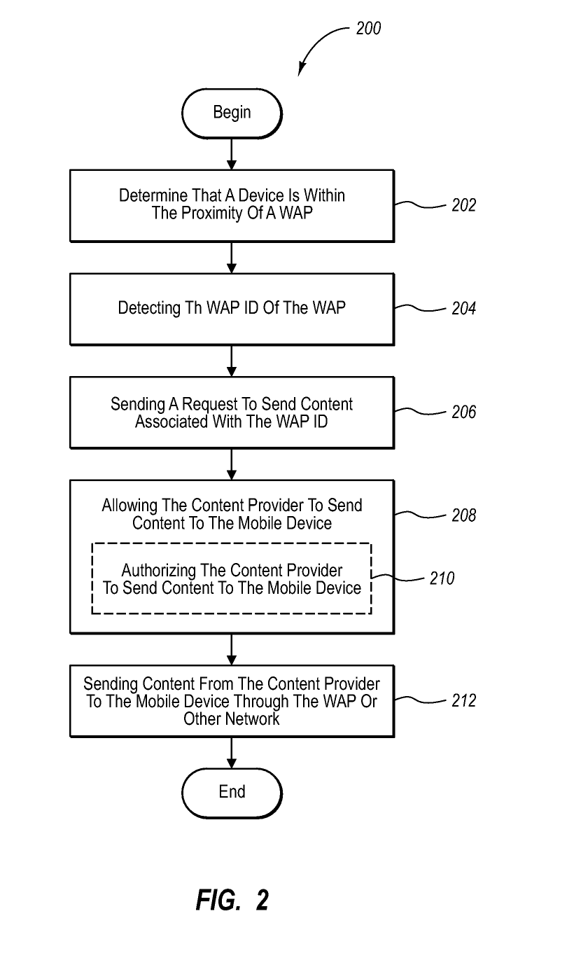

With particular attention now to FIG. 2, a flowchart illustrates one exemplary implementation of a method for a content provider to send content to a LWN-capable mobile device. The content provider may be proximate to the WAP or remote from the WAP. For a device, proximate to a WAP suggests that the device and the WAP can detect each other. Proximate to a WAP for a content provider does not mean that the content provider is within range of the WAP, but rather that the content provider is associated with the WAP. The content provider may be outside the range of the WAP but still proximate to (or associated to) the device. Embodiments of the invention therefore facilitate, but are not limited to, enabling content providers that are proximate or local with respect to a LWN to deliver content to devices whose presence is detected. In the example illustrated in FIG. 2, the commands or logic for implementing the method are stored locally on the LWN-capable mobile device. As may be understood by one of ordinary skill in the art, the commands or logic could also be stored in the WAP, as discussed more fully below. Alternatively, the commands or logic can be distributed between the WAP and the LWN-capable device.

In FIG. 2, the system determines 202 that a LWN-capable mobile device is within the proximity of the WAP. Typically, this may require the device to be within the range of the WAP. Next, the device detects 204 an identifier associated with the WAP, such as the MAC address or other WAP ID, and sends it to the server which then determines which content provider is associated with that WAP ID. The associated content provider sends 206 a request to a content server to send content through the WAP or other network connection using a WAP key or other identifier associated with the WAP. The content provider is allowed 208 to send content to the LWN-capable mobile device. The content can therefore be delivered automatically. The device may then provide some sort of notification to the user regarding the delivered content. In one embodiment, the content provider may be authorized 210 to send content to the mobile device. The content is then sent 212 from the content provider to the LWN capable mobile device though the WAP or other network.

As briefly discussed above, FIG. 2 illustrates an embodiment where the device initiates the method by detecting the proximity of the WAP and sending a WAP identifier to the content server. In another embodiment, the WAP may initiate the method by detecting the proximity of the device, and sending an identifier or key (which may include a MAC address, ESN, or other signature) associated with the device to the content server along with a request to send content to the device. Thus, the content can be pushed to a device using either a LWN or a WAP.

The content provider can be the same as the provider of the LWN, associated locally with the LWN, or remote from the LWN. The following examples illustrate how a content provider can send content to a LWN-capable mobile device through a WAP of a LWN or other network. This ability to deliver content sent to mobile devices within a wireless communication network allows the wireless service provider to deliver presence-based content such that the content is relevant to the subscriber's specific physical location at the time the content is received by the subscriber. Optionally, the system also may protect subscribers' privacy, determine the type and quantity of content that subscribers receive, and insist that content received by subscribers in the vicinity of the network is relevant to each subscriber's preferences.

An example implementation of method 200 of FIG. 2 will now be described in connection with wireless communication network 100 and local wireless network 101a of FIG. 1. In this example, mobile device 102b comes within the range 124a of LWN 101a. As soon as mobile device 102b enters the range 124a of LWN 101a, each of mobile device 102b and WAP 122a will automatically detect 202 the presence of the other and establish 204 a wireless network connection using IEEE 802.11.

In this example, the mobile device 102b has established a wireless network connection with WAP 122a of LWN 101a.

Next, the mobile device is sent 206 a request from a content provider to send content through WAP 122a or other network using the WAP key or other identifier to mobile device 102b. The content provider at 204 can be any other device that is network connected to LWN 101a. In this example, LWNS 120a is the content provider, and the operator of a business named “Bob's Book Store” operates LWNS 120a in furtherance of the business of Bob's Book Store. The business operator has also located WAP 122a near the front door of the shop. This location for WAP 122a has been chosen so that potential customers who pass with their LWN-capable mobile devices within 150 feet of the front door of Bob's Book Store can be solicited to make purchases at Bob's Book Store. The operator has also loaded an advertisement on LWNS 120a directed to the users of mobile devices that come within the range 124a of WAP 122a. The advertisement is an SMS text message that reads, “Come on over to Bob's Book Store! We'll give you a 10% discount on any purchase made in the next 15 minutes! Hurry before this offer expires!” The message also includes a unique advertisement number, corresponding to the time that the advertisement is generated, so that, upon redemption, Bob's Book Store can determine exactly when each advertisement was sent, and therefore, when each 15 minute offer expires. Other offers could also be sent. Therefore, in this example at 204, content server 118 will receive a request from LWNS 120ato send this advertisement to mobile device 102b.

Alternatively, the content provider 204 may not be located near the WAP 122a, but may be interested in communicating with devices who are in proximity to a specific region. The region could be the range of the WAP 122a or may extend to a wider geographic area. If the region is within range of a WAP 122a, users of LWN-capable devices can be “mapped” to being near the region via the WAP ID. Using this technique a content provider may send content to a device that is related, for example, to goods and services that are located in the region that is geographically near the WAP. Thus, the content need not be located within range of the WAP and may be sent remotely from the content provider 204 to the device.

Next, at 208, the mobile device 102b allows the LWNS 120a of Bob's Book Store to provide content to mobile device 102b and, Bob's Book Store sends content to the LWN-capable mobile device. As previously mentioned, the content may be sent through the LWNS 120a of Bob's Book Store, or by using the identifier key of LWNS 120a and sending the content through another network connected to the mobile device 102b. In another example, the identifier key or other unique identifier of the LWNS 120a may be used to obtain content from a remote server.

According to one embodiment, allowing 208 the content provider to send content to the mobile device includes authorizing the content provider to send content to the mobile device 102b. This may entail the user of a content server 118 of a wireless communication network 100, which receives notification that the device 102b has established the wireless connection, sending an authorization to the content server. This notification can be received by way of a communication from a server associated with WAP 122a, such as LWNS 120a across IP Network 126 and through one or more gateways 116. Alternatively, this notification can be received by way of a communication from mobile device 102b through one or more BTSs 104, BSC 106, and PDSN 108. As part of the authentication process, the content server 118 can determine at 206 if LWNS 120a is authorized to provide content to mobile device 102b using any one of, or combination of, various techniques.

One technique can be to check for the content provider on an access list of authorized content providers. The access list can be defined by the wireless service provider that manages wireless communication network 100 and can contain all content providers that have been granted access to send content to all subscriber LWN-capable mobile devices of wireless communication network 100. Using this technique, it is not important to identify the specific mobile device involved; only that mobile device 102b is a subscriber to wireless communication network 100. Alternatively, the access list can be specific to mobile device 102b and can contain only those content providers that have been granted access to send content to mobile device 102b. Using this technique, the specific mobile device involved may be identified in order to determine if the specific mobile device should receive content from the specific content provider.

Another technique can be to check for the content provider on an access list of authorized content providers, where the access list is defined by the user of mobile device 102b. The access list can contain all content providers that have been granted access to send content to mobile device 102b. Using this technique, the user of mobile device 102b is able to insert his own preferences into the ability of content providers to send content to mobile device 102b. For example, using this technique a user of 102b can designate that he would like to receive content from all book stores. More specifically, using this technique the user of mobile device 102b can designate that he would like to receive content from this specific Bob's Book Store franchise or any Bob's Book Store franchise. A variation on this technique is where the access list includes all content providers that are listed in a contact list of mobile device 102b. Using this variation technique, it is assumed that if the user of mobile device 102b has added a content provider to a contact list of mobile device 102b, then the user is willing to receive content from the content provider. For example, using this technique, if the user of mobile device 102b has added “Bob's Book Store” to his contact list, then Bob's Book Store will be allowed to send content to mobile device 102b. Thus, the user of the mobile device 102b may create a list of content providers from whom he/she is willing to receive content from. This list may be stored or cached in the mobile device 102b or may be saved as a series of user preferences with the mobile service provider.

At 210, any combination of the above techniques can also be performed in order for content server 118 to determine if LWNS 120a is “authorized.” It should be understood that LWNS 120a itself might be identified as being authorized, or LWNS 120a might be identified as being authorized because of some grouping to which it belongs. An example of such a grouping can be the group of all servers operated by any Bob's Book Store franchise. In this example, content server 118 searches one of the lists described above for a unique identifier corresponding to LWNS 120a of Bob's Book Store to determine if LWNS 120a is “authorized” to send content to mobile device 102b.

If, at 210, content server 118 determines that LWNS 120a is authorized, content server 118 at 208 will allow LWNS 120a to send the advertisement described above to mobile device 102b through the WAP 122a. If, on the other hand, at 210 content server 118 determines that LWNS 120a is not authorized, content server 118 will not allow LWNS 120a to send any content to mobile device 102b through the WAP 122a.

A second example implementation of method 200 of FIG. 2 will now be described in connection with wireless communication network 100 and local wireless network 101a of FIG. 1. In this second example, prior to 202, mobile devices 102b and 102c each came within the range 124a of LWN 101a. As described above, as soon as each mobile device 102a or 102b enters the range 124a of LWN 101a, WAP 122a will automatically detect 202 the presence of each mobile device 102a or 102b and 204 establish a wireless network connection using IEEE 802.11 technology.

In this second example at 202, wireless communication network 100 receives notification that mobile device 102b has established a wireless network connection with WAP 122a of LWN 101a. Next, at 206, a content provider requests to send content to mobile device 102b. As described above, the content provider can be any device that is network connected to LWN 101a. In this second example, mobile device 102c can function as the content provider. In this second example, the user of both mobile device 102b and 102c subscribe to a personal networking service and the user of mobile device 102c would like to send an “introduction message” to the user of mobile device 102b.

A personal networking service is a service that identifies a network of acquaintances that lies between two individuals. The personal networking service is able to determine the shortest path between any two individuals in the network in order to determine the number of degrees of separation between the two individuals. For example, where the users of mobile devices 102b and 102c are both subscribers to a personal networking service, and if the users of mobile devices 102b and 102c have a common acquaintance, then there is one degree of separation between the users of mobile devices 102b and 102c. If, on the other hand, the users of mobile devices 102b and 102c do not have any common acquaintances, but each has a distinct acquaintance that is acquainted with a distinct acquaintance of the other, then there are two degrees of separation between the users of mobile devices 102b and 102c. This type of peer to peer relationship between devices is not limited to degrees of separation, but can be established using other parameters such as a contact list or a common attribute such as being on the same network.

The “introduction message” that the user of mobile device 102c would like to send is an MMS message that contains any information that the user wants to publish, such as, for example, interests, resume, age, or picture. The user of mobile device 102c would like to be able to send this information to any other users of the personal networking service with whom he comes in close physical proximity and with whom he is within predefined number of degrees of separation. That way, as the user of mobile device 102c is walking down the street he will be able to see, hear, or feel a menu on a user interface of mobile device 102c that lists other users who are subscribers to the same personal networking service and within a pre-defined number of degrees of separation from the user. By sending this introduction message, the user of mobile device 102c can make a “soft” electronic introduction to the user of mobile device 102b and then perhaps strike up an instant SMS text message of MMS conversation or voice conversation, which may ultimately lead to a face-to-face meeting between the two users. Since the introduction message is intended to be sent only to other users who are connected to the same WAP, any resulting face-to-face meeting of the two users will at most require traveling a distance equal to the diameter of the range boundary of the WAP, which in this case would be at most approximately 300 feet. Therefore, in this example at 206, a content server 118 will receive from mobile device 102c a request to send this introduction message to mobile device 102b.

The content server 118 will determine whether mobile device 102c is authorized to provide content to mobile device 102b. Content server 118 can determine at 210 if mobile device 102c is authorized to provide content to mobile device 102b by a variety of techniques. One technique can be to check if mobile device 102b is subscribed to the same personal networking service as mobile device 102c. Alternatively, content server 118 can check if mobile device 102b is within a pre-defined number of degrees of separation from the user of mobile device 102c. Alternatively, content server 118 can check if mobile device 102c is listed in a contact list of mobile device 102b. Alternatively, content server 118 can use some other criteria or combination of criteria to determine if mobile device 102c is “authorized” to send content to mobile device 102b.

In this second example, at 210, content server 118 checks with a third-party personal networking service to determine if the user of mobile device 102c is within two degrees of separation from the user of mobile device 102b. If so, mobile device 102c is allowed 208 to send the introduction message. If not, mobile device 102c is not authorized to send the introduction message.

If content server 118 determines at 210 that mobile device 102c is authorized, content server 118 at 208 will allow mobile device 102c to send the introduction message described above to mobile device 102b through the WAP 122a. If, on the other hand, content server 118 determines at 210 that mobile device 102c is not authorized, content server 118 at will not allow mobile device 102c to send the introduction message to mobile device 102b through the WAP 122a.

III. Method for Sending Presence-Based Content to Mobile Devices

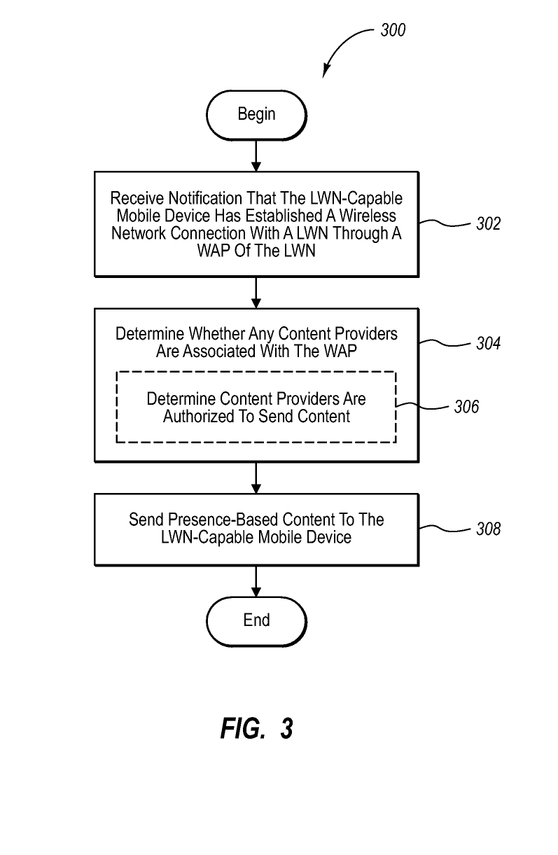

FIG. 3 presents one embodiment of a method for a wireless service provider to send presence-based content to a LWN-capable mobile device. At 302, notification is received that the LWN-capable mobile device has established a wireless network connection with a LWN through a WAP of the LWN. Then at 304, it is determined whether any content providers are associated with that WAP. The association may be determined by a variety of parameters, such as providers who are in close proximity to the WAP, or providers who are located far from the WAP but are interested in communicating with people who are in the proximity of the WAP, or other parameters. If at 304 it is determined that any content providers are associated with the WAP, method 300 proceeds to 308 where presence-based content is sent to the LWN-capable mobile device for some or all of the content providers that are associated with the WAP. Optionally, at 306 it is determined if the content providers are authorized to send content. If authorized, then the method proceeds to 308 and sends the content to the mobile device. If, on the other hand, at 304 it is determined that no authorized content providers are associated with the WAP, then no presence-based content is sent to the LWN-capable mobile device. Alternatively, other non-local content may be sent to the device.

An example implementation of method 300 of FIG. 3 will now be described in connection with wireless communication network 100 and local wireless network 101b of FIG. 1. In this example, prior to 302, mobile device 102d comes within the range 124b of LWN 101b. As soon as mobile device 102d enters the range 124b of LWN 101b, each of mobile device 102d and WAP 122b will automatically detect the presence of the other and establish a wireless network connection using IEEE 802.15 technology.

In this example, at 302, content server 118 of wireless communication network 100 receives notification that mobile device 102d has established a wireless network connection with WAP 122b of LWN 101b. This notification can be received as described above in connection with FIG. 1.

Next, at 304, content server 118 determines the proximity of the mobile device 102d to the location of the WAP 122b. In this exemplary method 300, it is understood that the “location” of WAP 122b can refer either to the fixed geographic location of WAP 122b or to the location of WAP 122b with respect to a moveable vehicle such as a ship, plane, train, or bus. Therefore, the proximity of the mobile device and the WAP 122b can be determined in terms of precise geographic coordinates (such as the exact latitude, longitude, and height with relation to sea level) or in terms of location relative to a moveable vehicle (for example, at the stern of the third deck of a particular cruise ship, or on the caboose of a particular train). In another example, it is not the precise location of the device but rather the presence of the device to the LWN (as previously indicated, many LWNs have a limited range) that enables local content to be sent.

As previously described, the content server 118 may be the provider of the LWN and can therefore send content directed to any device that is connected to the LWN. In other instances, the content server 118 can determine at 304 the proximity the mobile device 102d to the WAP 122b by using a variety of techniques. The location of the WAP can be determined by checking a publicly or privately accessible list of the WAP locations, where a unique identifier of WAP 122b can be cross-referenced to the corresponding location of WAP 122b. A third alternative technique for determining the location of WAP 122b could be for content server 118 to receive the location of WAP 122b simultaneously or subsequently to receiving notification that mobile device 102d has established a wireless connection with WAP 122b. This location information can be transmitted by, for example, by LWNS 120b or mobile device 102d. The device can also ‘sniff’ the ID of the WAP 122b (such as the MAC address) and communicate that ID to a server 118, in which case the server 118 can determine what content is associated with that WAP ID and deliver it to the mobile device 102d. Advantageously, this enables content to be delivered to a device without requiring the device to access the wireless network through the WAP. For example, a dual mode WIFI/CDMA device can use the WIFI aspects of the device to identify IDs associated with local WIFI access points. These IDs (such as MAC IDs) can serve as an index to a content server.

With this information, the content server 118 can determine whether any authorized content providers are located within a particular distance from the location of WAP 122b. Content server 118 can determine at 306 if any authorized content providers are located within a particular distance from the location of WAP 122b by a variety of techniques. One technique can be to check a list of authorized content provider locations that is stored in a database on content server 118 and calculate the distance between each authorized content provider and WAP 122b. The list of authorized service providers can be defined as described above in connection with FIG. 2.

Where an authorized content provider does not have a fixed geographic location, nor a fixed location on a vehicle, such as is the case with content providers that are other mobile devices, the location of the content provider can be determined approximately by the determining the location of the WAP to which the content provider is currently network connected. For example, if a mobile device is network connected to a WAP having a range of 100 feet, then the location of the mobile device can be determined within 100 feet by determining the location of the WAP.

Therefore, at 304, if the particular distance of the mobile device 102d from the location of WAP 122b is 2000 feet, content server 118 can determine whether any authorized content providers are located within 2000 feet of WAP 122b using one of several different approaches to determining distance. One approach that content server 118 can use is to calculate the exact straight-line distance between an authorized content provider and WAP 122b. Another approach that content server 118 can use is to calculate the “walking distance” between an authorized content provider and WAP 122b. The term “walking distance” is used herein to denote a measure of actual distance that a user of a mobile device must travel in order to arrive at the location of an authorized content provider. Thus “walking distance” takes into account publicly accessible thoroughfares such as walkways or streets; required changes in elevation; and any obstacles that may impede a user of a mobile device from walking in a straight line to the location of an authorized content provider.

The current example implementation of method 300 of FIG. 3 will now continue to be described in connection with wireless communication network 100 and local wireless networks 101b and 101c of FIG. 1. In this example, at 304 content server 118 can determine that LWNS 120c and mobile device 102e, which are both network connected to LWN 101c through WAP 122c, are content providers that are located within 2000 feet of the location of WAP 122b. The approximate locations of LWNS 120c and mobile device 102e can be determined with reference to the location of WAP 122c since both LWNS 120c and mobile device 102e are network connected to WAP 122c.

At 308, content server 118 sends presence-based content to the mobile device 102d for LWNS 120c. In this example, WAP 122c is operated by a music store named “Bob's Music Store” and is located near the entrance to Bob's Music Store. LWNS 120c is also operated by Bob's Music Store and contains advertisements for new music CDs currently being sold at Bob's Music Store. According to one example, the name and location of WAP 122c corresponding to LWNS 120c and Bob's Music Store is stored in a list of authorized content providers on content server 118. Therefore, at 306 the content server 118 determines that LWNS 120c is authorized to send presence-based content to mobile device 102d and is located within 2000 feet of WAP 122b, then at 308 content server 118 can send presence-based content for LWNS 120c.

The presence-based content sent to mobile device 102d can comprise a notification of the approximate street address of each of the content providers that are located within the particular distance from the location of WAP 122b. For example, the message can be a SMS text message that reads, “Bob's Music Store is located at 20 East 200 South.” Alternatively, the presence-based content sent to mobile device 102d can comprise a notification of the approximate walking distance and walking directions to arrive at each of the content providers that are located within the particular distance from the location of the WAP 122b. For example, the message can be a SMS text message that reads, “Bob's Music Store is located approximately 500 feet south, south east, of your current location. You can arrive at Bob's Music Store approximate location by traveling 2 blocks south on Main Street and then traveling 20 feet west after turning right on 200 South.”

According to the second example described previously, at 308, content server 118 will send presence-based content for mobile device 120e to mobile device 102d. In this example, the user of mobile device 120e is named “Fred” and the users of mobile devices 120d and 120e are both subscribed to a personal networking service as described above. In this example at 304, it was determined that the approximate location of mobile device 120e was within 2000 feet of the approximate location of mobile device 102d and that the users of mobile devices 120d and 120e were within a pre-defined number of degrees of separation from each other. Therefore, at 308, content server 118 might send a presence-based text message to mobile device 120d that reads, for example, “Fred is located approximately 500 feet south, south east, of your current location. You can arrive at Fred's approximate location by traveling 2 block south on Main Street and then traveling 20 feet west after turning right on 200 South.”

These examples illustrate how a wireless service provider can determine the approximate location of a LWN-capable mobile device by determining the location of a wireless access point to which the LWN-capable mobile device is connected. The wireless service provider can then compare this approximate location to the locations or approximate locations of other content providers in order to send presence-based content for each content provider within a particular distance from the approximate location of the LWN-capable mobile device. This allows the wireless service provider to send content to subscribers. Optionally, the system may also include an authorization process within the wireless service provider's wireless communication network in order to protect subscribers' privacy, by determining the type and quantity of content that subscribers receive, and sending only content that is relevant to the subscriber's specific location at the time the content is sent to the subscriber.

IV. Method for Notifying a Mobile Device User of Presence-Based Content

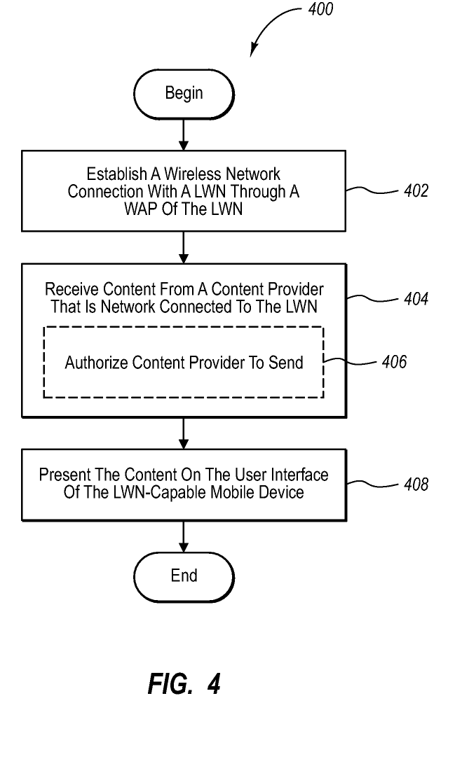

With particular attention now to FIG. 4, a flowchart illustrates one exemplary implementation of a method for notifying a user of a LWN-capable mobile device of available content. At 402, a wireless network connection is established with a LWN through a WAP of the LWN. At 404, content is received from a content provider that is network connected to the LWN. The content provider may be local and connected to the LWN or remote from the LWN.

At 408, content is presented on a user interface of the LWN-capable mobile device. Optionally, at 406, it is determined whether the content provider is authorized to send content to the LWN-capable mobile device. If at 406 it is determined that the content provider is authorized, method 400 proceeds to 408 where the content is presented on the user interface. If, on the other hand, at 406 it is determined that the content provider is not authorized, method 400 ends and the content is not presented on the user interface. The content can be presented over the connection to the LWN. Alternatively, the content can be presented over another network such as the user's cellular telephone network.

An example implementation of method 400 of FIG. 4 will now be described in connection with wireless communication network 100 and local wireless network 101c of FIG. 1. In this example, at 402, mobile device 102e comes within range of LWN 101c. As described above, a network connection will automatically be established between mobile device 102e and LWN 101c using IEEE 802.15 technology.

At 404, mobile device 102e receives content from LWNS 120c which is network connected to WAP 122c. In this example, LWN 101c is a home wireless network that has been set up by the user of mobile device 102e. Likewise, LWNS 120c is a server that the user of mobile device 102e has set up at his home as part of his home wireless network. Similarly, WAP 122c has been set up by the user of mobile device 102e in order to allow the user to communicate with his home LWN. The content that is sent at 404 in this example can include a listing of all the services that the user can control in his home through LWNS 120c such as the lights, personal computers, heating, air conditioning, music, TV, hot tub, sprinklers, and the like. In addition, the content can include an invitation to download pictures from mobile device 102e to LWNS 120c.

According to one embodiment, at 406, the mobile device 102e determines whether LWNS 120c is authorized to send content to mobile device 102e. This determination can be made, for example, by checking an access list of authorized content providers stored or cached on mobile device 102e for a unique identifier corresponding to LWNS 120c. Likewise, this determination can be made by checking an access list of authorized content providers stored on content server 118. In this example it should be noted that before LWNS 120c sends content to mobile device 102e, LWNS 120c will also verify that mobile device 102e is authorized to receive the content, since LWNS 120c will limit who is able to control the services in the home of the user of mobile device 102e.

If at 406 it is determined that LWNS 120c is authorized to send content to mobile device 102e, or if there is no authorization process, then the method 400 proceeds to 408 where the received content is presented on a user interface of mobile device 102e. The user interface used at 408 can be any conceivable type of user interface, including, but not limited to, a graphical user interface, an auditory user interface, or a tactile user interface. For example, the list of home services presented at 408 could be visually displayed to the user on a visual display of a graphical user interface. This visual display could include a menu that can be browsed by the user of mobile device 102e. Likewise, the list could be audibly presented on an audible user interface that presents information audibly to the user. Similarly, the list could be the presented to the user through a tactile user interface or by activating a vibrator function on mobile device 102e to alert the user of the mobile device 102e that content has been received. The user can then interact with the user interface where the content is presented, or with another user interface of mobile device 102e, in order to control the lights, music, TV, hot tub, or sprinklers of his home as he is approaching his home.

If, on the other hand, at 406 it is determined that LWNS 120c is not authorized to send content to mobile device 102e, method 400 proceeds to 410 where the content is not presented on the user interface of mobile device 102e.

A second example implementation of method 400 of FIG. 4 will now be described in connection with wireless communication network 100 and local wireless network 101a of FIG. 1. In this second example, prior to 402, mobile device 102b comes within the range of LWN 101a. As described above, as soon as mobile device 102b enters the range 124a of LWN 101a, WAP 122a will automatically detect the presence of mobile device 102b and establish a wireless network connection using IEEE 802.11 technology.

In this second example, at 402, mobile device 102c comes within range of LWN 101a. As soon as mobile device 102c enters the range 124a of LWN 101a, the mobile devices 102b and 102c and WAP 122a will automatically detect the presence of the other and establish a wireless network connection using IEEE 802.11 technology.

At 404, mobile device 102c receives content from mobile device 102b. In this example, the users of mobile devices 102b and 102c are subscribers to a common personal networking service, as described above. The content that is sent at 404 in this second example is an introduction message, as described above, that contains information about the user of mobile device 102b.

At 406, mobile device 102c determines whether mobile device 102b is authorized to send content to mobile device 102c. This determination can be made, for example, by sending a unique identifier received from mobile device 102b as well as a unique identifier from mobile device 102c to a server of the personal networking service (not shown) that is connected to IP Network 126. Access to IP Network 126 can be granted to mobile device 102c through WAP 122a and LWNS 120a. The server of the personal networking service (not shown) can determine the number of degrees of separation that the users corresponding to the two unique identifiers are from one another, and relay this number back to mobile device 102c. Mobile device 102c can then compare this number to a maximum number that has previously been designated by the user in order to determine if the user of mobile device 102b is “authorized” to send content to mobile device 102c.

If at 406 it is determined that mobile device 102b is authorized to send content to mobile device 102c, method 400 proceeds to 408 where the received content is presented on a user interface of mobile device 102c. The user interface employed at 406 can be any conceivable type of user interface, as described above in the first example for FIG. 400.

If, on the other hand, at 406 it is determined that mobile device 102b is not authorized to send content to mobile device 102c, the content is not presented on the user interface of mobile device 102c. In this example, mobile device 102b is authorized to send content to mobile device 102c. Therefore, in one embodiment, the method 400 terminates and never proceeds to 408.

A third example implementation of method 400 of FIG. 4 will now be described in connection with wireless communication network 100 and local wireless network 101a of FIG. 1. In this third example, at 402, mobile device 102b comes within range of LWN 101a, and mobile device 102b automatically establishes a wireless network connection with WAP 122a using IEEE 802.11 technology, as described above.

At 404, mobile device 102b receives content from LWNS 120a. In this example, LWNS 120a is operated by a fast food restaurant named “Bob's Fast Food” and contains interactive text message advertisements that enable a user to place his order electronically from a mobile device. WAP 122a is located near the cashier of Bob's Fast Food, and the interactive text message advertisements enable Bob's Fast Food to take orders and serve customers more quickly.

At 406, mobile device 102b determines whether LWNS 120a is authorized to send content to mobile device 102b. This determination can be made, for example, by checking a list of authorized content providers stored on mobile device 102b. For example, the user of mobile device 102b may have designated that all Bob's Fast Food restaurants are authorized to send content to mobile device 102b.

If at 406 it is determined that LWNS 120a is authorized to send content to mobile device 102b, method 400 proceeds to 408 where the received content is presented on a user interface of mobile device 102b. The user interface used at 408 can be any conceivable type of user interface, as described above in the first example for FIG. 400. In this third example, the interactive text message advertisement received can automatically appear on the user interface and can read, or announce audibly, “Welcome to Bob's Fast Food. Please enter your order.” Also as the ad is received on the device, it can trigger a tactile sensation such as a vibration to alert the user. The user can then reply to this message by typing or speaking instructions on mobile device 102b that are transmitted back to LWNS 120a such as, for example, “Yes. I would like a hamburger with extra pickles, a medium root beer, and a large french fries with no salt.” Some form of electronic confirmation and payment can then be transacted between LWNS 120a and mobile device 102b. This interchange can occur, for example, between the time that the user of mobile device 102b enters range 124a and the time that the user arrives at the front door of Bob's Fast Food. Then, when the user of mobile device 102b arrives at the actual cashier of Bob's Fast Food, the order can be filled and waiting for the user to consume.

If, on the other hand, at 406 it is determined that LWNS 120a is not authorized to send content to mobile device 102b, method 400 typically terminates and no content is presented on the user interface of mobile device 102b.

V. Method for Obtaining Location Information for a Mobile Device

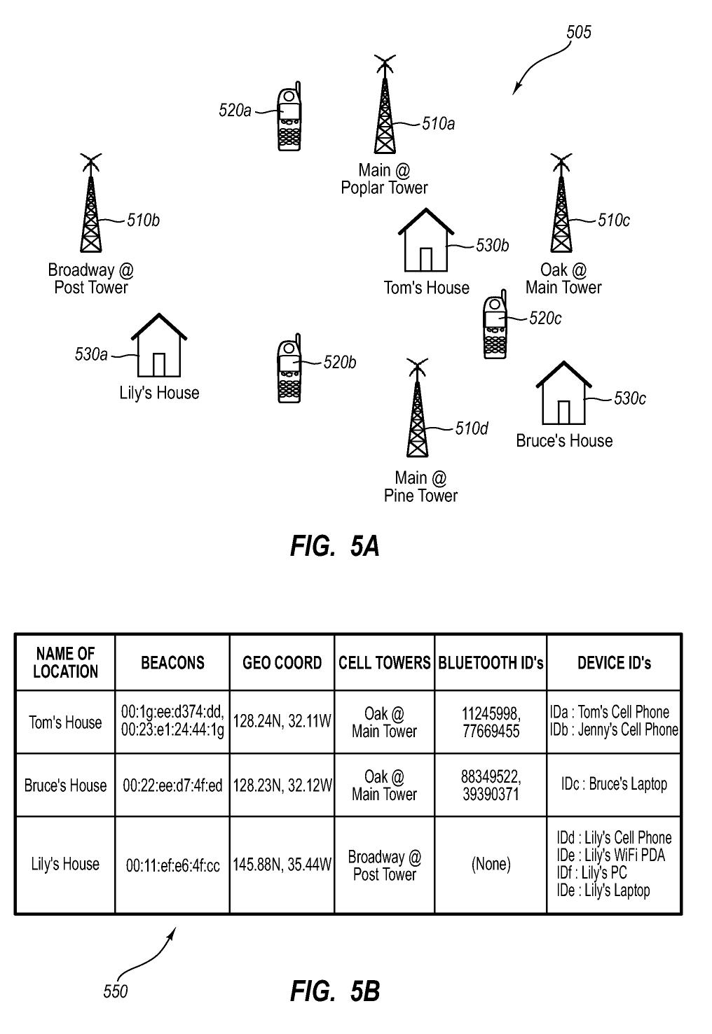

FIGS. 5A and 5B illustrate a method of obtaining location information for an object using a variety of networks and devices. FIG. 5A illustrates an exemplary environment 505 wherein multiple networks and devices 520a-520c operate. In this example, the environment 505 includes a variety of devices 520a-520c and cellular network towers 510a-510d, which are a type of BTS. The environment 505 also includes a plurality of locations 530a-530c which may not communicate directly with any network, and thus may not directly communicate any location information with any network. According to one aspect of the invention, however, the system may collect data from a variety of networks and devices in order to create a database of location information which may be used to locate various objects in the environment 505 by comparing the object's proximity to any of the known locations in the environment. The database of devices, access points, locations (and their names), multiple sources and types of location information (GPS coordinates, cell tower-derived location estimates, street addresses, etc) may be updated and otherwise managed as devices move from one location to another and as location information, location names, and characteristics are added/deleted and/or are changed over the course of time and operation of the system. Furthermore the database itself may be centralized or distributed, and may even have subsets of its data cached locally on various mobile devices, computers, and wireless network access points.

FIG. 5B is an example of a database 550 that may be created from the various objects in the environment 505 illustrated in FIG. 5A. The database 550 can consolidate presence information to increase the accuracy of service/location information. For example, a device with WiFi and GPS can use its GPS to refine WiFi-beacon location data that is shared with other devices that lack GPS data capabilities. The consolidation of presence information, service, and/or location information allows determination of proximity to locations and other communication networks, thus increasing the accuracy, reach, and flexibility of ways that data and content can be shared across networks and with users whose devices have limited or inaccurate location/proximity capabilities.

Such a database 550 may be populated a variety of ways, such as by receiving location/proximity information from devices of various types in the field, some set of which have location/proximity information known about them that can be used to improve the accuracy of information and to share such information with other connected devices. Devices that supply location/proximity information may have the ability to generate such information internally or via cellular towers, WiMax transmitters, or satellite GPS systems. By way of example only, candidate devices could include GPS-equipped mobile devices, mobile devices that can be located using cellular tower triangulation techniques, PCs which are connected to access points that have know locations or whose location may be known, estimated, or inferred from other access points in the network to which it is connected or for which addresses have been entered/supplied by end-users directly. Such a database of location/proximity information itself may be centralized or distributed or split-and-shared. Furthermore, some designs may include subsets of the data which might be cached or stored locally on various devices, computers, and wireless network access points to allow only subsets of the data to be shared or to enable certain modes of useful operation even when devices may be temporarily (or by design) disconnected to any functioning network.

As shown in FIGS. 5A and 5B, the database includes a list of various locations 530a-530c in the environment 505, with the various beacons, cell towers 510a-510d, Bluetooth IDs, and geographic coordinates of the locations 530a-530c. Using this database 550, the system may provide location information that may be used to accurately determine the proximity and location of the devices, content providers, and various other objects in an environment. In some instances, the system may generate a computerized grid of information relating to the location of all the devices and networks in an area.

Thus, one aspect of the invention is the ability to create a multi-platform repository of location information that may be used to provide location information. Advantageously, this provides a robust and accurate system that is capable of providing location information for a wide variety of objects, which spans over many platforms and networks. In one embodiment, the system may be able to utilize the accuracy of one type of network to provide better location information. For example, WiFi networks may be generally considered less accurate in determining the location of the device than GPS systems. Thus, in a traditional system, the presence-based content sent to a device based on the location information provided by a WiFi network would be less accurate and relevant than provided in a GPS system. Alternatively, the location identified via the WiFi network may be less accurate than the location identified by a GPS system. According to one embodiment of the invention, however, a device operating on a WiFi network may be able to utilize the more accurate location information supplied by a GPS device stored in the database. Thus, an advantage of using location information from a variety of sources is the ability to provide accurate presence-aware services and content for devices despite network limitations.

Examples of location information sources include WiFi networks and devices, a GPS networks devices, cellular networks and devices including tower or sector information, local area networks and devices, wide area networks and devices, Bluetooth networks and devices, and various other communication networks and devices. In some instances, the location data may be retrieved from another database. For example, the identification of a particular sector may be used to access another database that provides coordinates for the location of the sector.

For example, the creation and/or maintenance of the database 550 may relay on various sources, which may often be disparate or unrelated. The database 550 illustrates, for instance, that the database can collect information from various sources as described herein. Once the database is populated with this type of data from various sources (not all sources are required for operation), then the location of a device can be more accurately identified by combining this information accessed from the database. For example, the GPS data obtained from a GPS enabled device can be used to improve the location data associated with a WiFi network.

This type of information can be used to expand beyond identifying the location of a device such as a cellular telephone. The information stored in the database can be accessed to identify or approximate the location of a laptop computer or PC computer, for example. The database can be used to identify the location of disparate or unrelated devices. The database and/or the information collected from devices operating in a network can also be used to provide a holistic view of devices operating in a network.

Embodiments of the invention can be used to detect proximity of one device to another device or to detect proximity of a device to another entity, network, and the like. Determining the location of a device can be performed in response to a request from a device, automatically by a service, by a request from a content provider, and the like. For example, a WiFi network may detect the presence of a device. The location of the device can then be requested. This may include accessing the database or causing a subsequent request to be made to the device to discover another information reference such as a GPS reading. The service or server identifying or providing the location of the device can then analyze the various sources of location information to provide a more accurate location of the device. This identification can be then transmitted to the device, to a network, to a content provider, and the like or any combination thereof.

Embodiments of the invention utilize multiple location or proximity methodologies such as WiFi beacons, GPS, cell tower IDs, network router IDs, Bluetooth IDs, and the like. When data associated with these systems are accumulated, there is a greater accuracy of location and/or services. For example, a single device with WiFi and GPS can use the GPS to refine the location of the WiFi beacon.

A connected device that does not have location data can still be made presence and proximity aware by receiving information from a database (such as the database 550) which possesses such information from other location-aware devices that may happen to be connected to the same (or associated) access points, and thus can also be informed of other devices and locations nearby. This enables diverse determination of proximity to locations and other devices.

One embodiment of the database includes various location objects and each location object may be associated with one or more fields that may include, but are not limited to, a name (e.g., Tom's House), a list of WiFi beacons, coordinates, a list of cell towers, a list of Bluetooth devices, a list of devices that are locally connected to communication access points. The database can also include other data, such as device identifiers (laptop, PC, cell phone, PDA, etc.). The database 550, for example, illustrates one example of devices that are associated with location objects.

The database 550 can be created, modified, updated, and the like in real time. For example, a device may detect a WiFi beacon, but the location of the WiFi beacon may be unknown. The GPS data collected by the device can then be used to identify the location of the WiFi beacon in the database. Thus, the database can be used for multiple types of devices.

Another advantage of embodiments of the invention is the ability to allow devices that operate in different networks to become aware of devices in disparate or distinct networks. For example, a WiFi beacon whose location is known may communicate with wireless devices that are operating on different wireless networks. The location of the WiFi beacon can be used to identify the location of one device to another because each device may be able to access and use the database and because the WiFi beacon is communicating with the wireless devices.

The database or a server computer having access to the database can periodically poll devices or the devices themselves can push data to the server or to the device having access to the database. By polling the devices in this manner, the locations of devices in a particular network or in a plurality of networks can be updated. For example, a laptop user connected to a particular access point (and this a radio beacon) may discover that their friend's cell phone is located nearby. In this example, the location of the cell phone was obtained using tower information and the location of the laptop was obtained by the location of the WiFi access point. In another embodiment, the location of the cell phone can be further defined by GPS data provided by the cell phone. This may allow the user of the laptop to discover that the cell phone is within the range of the access point. This illustrates that devices operating on distinct networks can be identified to each other and also illustrates how location from different sources is used to more accurately determine the location of at least one device.

In another example, the history of certain devices may be retained. For example, the last known location of a particular device may be retained. This can be done for a certain amount of time or indefinitely.

The database can accumulate information from multiple sources and use the information to provide location information or proximity location.

These examples illustrate how a user of a LWN-capable mobile device can be notified that presence-based content is available. Each of the examples includes the ability to authorize the content provider to send the content, allowing the user of the LWN-capable mobile device to receive presence-based content and determine the type and quantity of content that is received and allow only content that is relevant to the subscriber's specific location at the time the content is received.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system including a user operating a subscriber LWN-capable mobile device, a content provider, and a wireless access point, a method for the content provider to send content to the LWN-capable mobile device, the method comprising:
determining that a LWN-capable mobile device is within the proximity of the wireless access point;
retrieving the wireless access point identifier;
using the wireless access point identifier to find content for the LWN-capable mobile device without requiring user action; and
notifying the user that content is available on the LWN-capable device.

2. The method of claim 1, wherein the wireless access point identifier is a Ethernet MAC address.

3. The method of claim 1, wherein the content is created via an auction between a plurality of content providers.

4. The method of claim 1, wherein determining that the LWN-capable mobile device is within the proximity of the wireless access point comprises receiving location information from a plurality of communication networks and devices, and comparing the location information to data received from the LWN-capable mobile device.

5. The method of claim 4, further comprising creating a database of location information received from a plurality of communication networks and devices.

6. The method of claim 1, wherein requesting content for the LWN-capable mobile device further comprises at least one of:
the LWN-capable mobile device polling the network and requesting content based on an identifier of the wireless access point; or
the network requesting to send content to the LWN-capable device, wherein the content provider is allowed to send the content to the LWN-capable device.

7. The method according to claim 1, wherein the content sent by the content provider is presence-based content based on the presence of the LWN-capable mobile device.

8. The method of claim 1 where the content is sent via the wireless access point.

9. The method of claim 1 where the content is sent via some other wireless network, including a 802.11 wireless network.

10. The method according to claim 7, wherein the presence-based content sent to the LWN-capable mobile device comprises a notification of the approximate street address of a content provider that is located within a particular distance from the location of the wireless access point.

11. The method according to claim 7, wherein the presence-based content sent to the LWN-capable mobile device comprises a notification of the approximate traveling directions to arrive at a content provider located within a particular distance from the location of the wireless access point.

12. The method according to claim 1, the method further comprising:
determining whether the content provider is authorized to send content to the LWN-capable mobile device.

13. The method according to claim 12, the method further comprising:
blocking the content provider from sending content to the LWN-capable mobile device through the wireless access point if the content provider is not authorized.

14. The method according to claim 12, wherein determining whether the content provider is authorized comprises checking for the content provider on an access list of authorized content providers, where the access list is defined by the user of the LWN-capable mobile device, and contains all content providers that have been granted access to send content to LWN-capable mobile devices.

15. The method according to claim 14, wherein the access list is stored within the cache or memory of the LWN-capable mobile device.

16. The method according to claim 14, wherein the access list comprises all content providers listed in a contact list of the LWN-capable device.

17. The method according to claim 14, wherein the access list comprises all content providers within a pre-defined number of degrees of separation from the user of the LWN-capable mobile device in a personal networking service.

18. The method according to claim 12, wherein the content provider is associated with the wireless access point and the content is an advertisement for one or more goods or services that the content provider is offering in close physical proximity to the wireless access point.

19. In a system including a wireless service provider and a subscriber LWN-capable mobile device, a method for the wireless service provider to send presence-based content to the LWN-capable mobile device, the method comprising:
receiving notification that the LWN-capable mobile device has established a wireless network connection with a LWN through a wireless access point of the LWN;
associating the LWN-capable mobile device with the wireless access point;
determining whether any content providers are located within a particular distance from the location of the wireless access point; and
sending presence-based content to the LWN-capable mobile device for one or more of the content providers that are located within the particular distance from the location of the wireless access point.

20. The method according to claim 19, the method further comprising:
determining whether the content provider is authorized to send content to the LWN-capable mobile device.

21. The method according to claim 20, the method further comprising:
blocking the content provider from sending content to the LWN-capable mobile device through the wireless access point if the content provider is not authorized.

22. The method according to claim 20, wherein determining whether the content provider is authorized comprises checking for the content provider on an access list of authorized content providers, where the access list is defined by the wireless service provider and contains all content providers that have been granted access to send content to all subscriber LWN-capable devices.

23. The method according to claim 20, wherein determining whether the content provider is authorized comprises checking for the content provider on an access list of authorized content providers, where the access list is defined by the wireless service provider and contains all content providers that have been granted access to send content to the LWN-capable mobile device.

24. The method according to claim 20, wherein determining whether the content provider is authorized comprises checking for the content provider on an access list of authorized content providers, where the access list defined by the user of the LWN-capable mobile device and contains all content providers that have been granted access to send content to the LWN-capable mobile device.

25. The method according to claim 19, wherein at least one of the content providers is the operator of a second LWN with a second wireless access point.

26. The method according to claim 19, wherein at least one of the content providers is a second LWN-capable mobile device.

27. In a system including a LWN-capable mobile device that has a user interface, a method for notifying a user of the LWN-capable mobile device of available content, the method comprising:
establishing a wireless network connection with a LWN through a wireless access point of the LWN;
associating the LWN-capable mobile device with the wireless access point;
receiving content from a content provider that is network connected to the LWN; and
presenting the content on the user interface of the LWN-capable mobile device.

28. The method according to claim 27, the method further comprising:
determining whether the content provider is authorized to send content to the LWN-capable device.

29. The method according to claim 27, wherein presenting the content on the user interface comprises displaying the content on a visual display of a graphical user interface.

30. The method according to claim 27, wherein presenting the content on the user interface further comprises activating a vibrator function on the LWN-capable mobile device to alert the user of the LWN-capable mobile device that content has been received.

31. The method according to claim 27, wherein presenting the content on the user interface comprises making the content available on the user interface through a menu that can be browsed by the user of the LWN-capable mobile device.

32. The method according to claim 27, wherein the content provider is a second LWN-capable device.

33. The method according to claim 32, wherein the content received from the second LWN-capable mobile device comprises information about the user of the second LWN-capable mobile device.

34. The method according to claim 27, wherein the content provider is the operator of the LWN and the content is an interactive advertisement for one or more goods or services that the operator of the LWN is offering in close physical proximity to the wireless access point.

35. In a system including a user operating a subscriber LWN-capable mobile device, a content provider, and a plurality of networks and devices, a method for the content provider to send content to the LWN-capable mobile device, the method comprising:
receiving location information from the plurality of networks and devices;
determining that a LWN-capable mobile device is within the proximity of the plurality of networks and devices;
determining an approximate location of the LWN-capable mobile device;
using the approximate location to find content for the LWN-capable mobile device without requiring user action; and
notifying the user that content is available on the LWN-capable device.

36. The method according to claim 35, further comprising creating a database of location information from the plurality of networks and devices, the database used to determine the approximate location of the LWN-capable mobile device.

37. The method according to claim 35, wherein determining the approximate location of the LWN-capable mobile devices comprises evaluating the location information of any devices or networks detected by the LWN-capable mobile devices.

38. The method according to claim 36, wherein determining the approximate location of the LWN-capable mobile device comprises access the database of location information and retrieving the location of any networks or devices that have been detected by the LWN-capable mobile device.

39. The method according to claim 35, wherein the plurality of networks and devices include WiFi networks and devices, a GPS networks devices, cellular networks and devices, local area networks and devices, wide area networks and devices, and Bluetooth networks and devices.
